(19) United States
(12) Patent Application Publication
(10) Pub. No.: US 2022/0318482 A1
(43) Pub. Date: Oct. 6, 2022

(54) COMPUTER-READABLE RECORDING MEDIUM STORING DESIGN SUPPORT PROGRAM, DESIGN SUPPORT METHOD, AND DESIGN SUPPORT DEVICE

(71) Applicant: FUJITSU LIMITED, Kawasaki-shi (JP)

(72) Inventor: Moriyuki Santou, Kawasaki (JP)

(73) Assignee: FUJITSU LIMITED, Kawasaki-shi (JP)

(21) Appl. No.: 17/580,214

(22) Filed: Jan. 20, 2022

(30) Foreign Application Priority Data
Mar. 31, 2021 (JP) 2021-061032

(51) Int. Cl. G06F 30/3953; G06F 30/392; G06F 30/398

(52) U.S. Cl. CPC G06F 30/3953; G06F 30/392; G06F 30/398; G06F 2119/18

(57) ABSTRACT

A non-transitory computer-readable recording medium storing a design support program for causing a computer to execute a process including: identifying a signal wiring line of a multi-patterning wiring layer on a basis of layout data related to a circuit to be designed, and detecting a floating wiring line that is adjacent to the identified signal wiring line and has a part parallel to the signal wiring line; and determining an arrangement position of a cut metal that divides the detected floating wiring line on a basis of arrangement positions of cut metals arranged at both ends of the signal wiring line.

### CROSS-REFERENCE TO RELATED APPLICATION

This application is based upon and claims the benefit of priority of the prior Japanese Patent Application No. 2021-61032, filed on Mar. 31, 2021, the entire contents of which are incorporated herein by reference.

### FIELD

The embodiments discussed herein are related to a design support program, a design support method, and a design support device.

### BACKGROUND

In recent years, multi-patterning technology such as self-aligned double patterning (SADP) may be used as a process technology for high-density wiring. According to the multi-patterning technology, metal wiring lines spread on a wiring channel are divided and used for connection between gates. The division of the metal wiring lines is carried out by, for example, arranging a recognition layer (cut metal) for dividing the metal wiring lines on computer-aided design (CAD).

Examples of prior art include connecting floating metal to power supply potential or ground potential in a case where the floating metal forms coupling capacitance with a signal wiring line. Furthermore, there is a technique for suppressing forming of deep recesses on a surface of an interlayer insulating film at a time of embedding a wiring line in a groove. Furthermore, there is a technique related to a method of forming a dummy pattern in a semiconductor device having a multilayer metal wiring structure. Furthermore, there is a technique related to a method of forming a line pattern structure.

Examples of the related art include as follows: Japanese Laid-open Patent Publication No. 2011-222854; Japanese Laid-open Patent Publication No. 2011-049426; Japanese Laid-open Patent Publication No. 06-326106; and Japanese Laid-open Patent Publication No. 2012-044184.

### SUMMARY

According to an aspect of the embodiments, there is provided a non-transitory computer-readable recording medium storing a design support program for causing a computer to execute a process including: identifying a signal wiring line of a multi-patterning wiring layer on a basis of layout data related to a circuit to be designed, and detecting a floating wiring line that is adjacent to the identified signal wiring line and has a part parallel to the signal wiring line; and determining an arrangement position of a cut metal that divides the detected floating wiring line on a basis of arrangement positions of cut metals arranged at both ends of the signal wiring line.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a design support method according to a first embodiment;

FIG. 2 is an explanatory diagram illustrating an exemplary system configuration of an information processing system 200;

FIG. 3 is a block diagram illustrating an exemplary hardware configuration of a design support device 101;

FIG. 4 is a block diagram illustrating an exemplary functional configuration of the design support device 101;

FIG. 5 is an explanatory diagram (No. 1) illustrating exemplary operation of a design support device 101 according to a second embodiment;

FIG. 6 is an explanatory diagram (No. 2) illustrating exemplary operation of the design support device 101 according to the second embodiment;

FIG. 7 is an explanatory diagram (No. 3) illustrating exemplary operation of the design support device 101 according to the second embodiment;

FIG. 8 is an explanatory diagram (No. 4) illustrating exemplary operation of the design support device 101 according to the second embodiment;

FIG. 9 is an explanatory diagram (No. 5) illustrating exemplary operation of the design support device 101 according to the second embodiment;

FIG. 10 is an explanatory diagram (No. 6) illustrating exemplary operation of the design support device 101 according to the second embodiment;

FIG. 11 is an explanatory diagram (No. 7) illustrating exemplary operation of the design support device 101 according to the second embodiment;

FIG. 12 is an explanatory diagram (No. 8) illustrating exemplary operation of the design support device 101 according to the second embodiment;

FIG. 13 is a flowchart illustrating an example of a design support processing procedure of the design support device 101 according to the second embodiment;

FIG. 14 is a flowchart illustrating an example of a specific processing procedure of a first cut metal arrangement process;

FIG. 15 is a flowchart illustrating an example of a specific processing procedure of a second cut metal arrangement process;

FIG. 16 is an explanatory diagram (No. 1) illustrating exemplary operation of a design support device 101 according to a third embodiment;

FIG. 17 is an explanatory diagram (No. 2) illustrating exemplary operation of the design support device 101 according to the third embodiment;

FIG. 18 is a flowchart illustrating an example of a specific processing procedure of a third cut metal arrangement process;

FIG. 19 is an explanatory diagram (No. 1) illustrating exemplary operation of a design support device 101 according to a fourth embodiment;

FIG. 20 is an explanatory diagram (No. 2) illustrating exemplary operation of the design support device 101 according to the fourth embodiment;

FIG. 21 is an explanatory diagram (No. 3) illustrating exemplary operation of the design support device 101 according to the fourth embodiment;

FIG. 22 is a flowchart illustrating an example of a design support processing procedure of the design support device 101 according to the fourth embodiment; and

FIG. 23 is a flowchart illustrating an example of a specific processing procedure of a fourth cut metal arrangement process.

### DESCRIPTION OF EMBODIMENTS

However, according to the prior art, it is difficult to suppress crosstalk noise caused by capacitive coupling between signal wiring lines at distant positions via a floating wiring line in layout design using the multi-patterning technology.

In one aspect, the embodiments aim to determine an arrangement position of a cut metal that reduces crosstalk noise efficiently.

Hereinafter, embodiments of a design support program, design support method, and design support device will be described in detail with reference to the drawings.

### First Embodiment

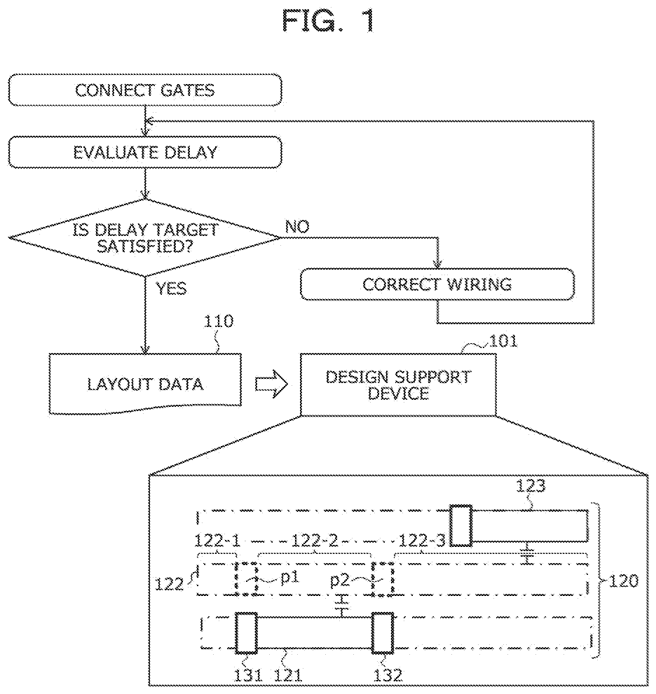

FIG. 1 is an explanatory diagram illustrating an example of a design support method according to a first embodiment. In FIG. 1, the design support device 101 is a computer that supports design of a circuit to be designed. The design support device 101 is constructed by, for example, a personal computer (PC), a server, and the like. The circuit to be designed is, for example, a semiconductor integrated circuit such as a central processing unit (CPU), a graphics processing unit (GPU), and a memory.

Here, multi-patterning technology may be used as a process technology for high-density wiring to be used in layouts such as CPU design. According to the multi-patterning technology, unlike a method of drawing a figure of a metal wiring line needed to connect gates, a wiring part obtained by dividing metal wiring lines spread on a wiring channel is used for connection between gates.

In order to divide the wiring lines spread on the wiring channel as different signals, a recognition layer for dividing the metal wiring line called a cut metal is arranged on CAD. Since the wiring lines generated by the multi-patterning technology are extended wiring lines, there is a portion not used as a signal wiring line in the wiring channel as a floating wiring line.

Accordingly, crosstalk noise tends to increase when a certain signal wiring line is capacitively coupled to a signal wiring line at a distant position via an adjacent floating wiring line. Since crosstalk noise is a factor for malfunction and hindering of high-speed operation, it is important to take measures to avoid crosstalk noise in layout design.

For example, some existing layout tools have a function of automatically arranging a cut metal in a case where different signals on a circuit are on the same wiring line. However, it is not possible to modify the arrangement position of the cut metal or to insert a new cut metal to reduce the crosstalk noise.

Furthermore, there is a prior art in which, in order to suppress crosstalk noise, floating metal is connected to power supply potential in a case where the floating metal forms coupling capacitance with a signal wiring line and the remaining floating metal is removed in a case where the remaining coupling capacitance value is larger than a predetermined capacitance value.

However, the wiring line generated by the multi-patterning technology tends to be an adjacent floating wiring line. Accordingly, according to the prior art, connecting the floating wiring line to the power supply causes the wiring channel to be tight, which is a great disadvantage. Furthermore, since it is not possible to remove the extended wiring line to reduce the coupling capacitance, it is not possible to utilize the prior art for the multi-patterning wiring.

Furthermore, it is conceivable to design using a transistor having strong noise immunity to suppress crosstalk noise. However, using a transistor having strong noise immunity has a disadvantage in terms of chip performance (e.g., operating speed is lowered.)

Furthermore, it is conceivable to insert cut metals into the floating wiring line on the chip as much as possible or randomly. However, a design rule related to the position where the cut metal may be inserted is complicated, and comprehensive processing causes an increase in man-hours. Meanwhile, in a case of inserting the cut metal randomly, the effect may not be exerted, which is not realistic.

Furthermore, it is also conceivable to evaluate the crosstalk generated with signals at a distant position via the adjacent floating wiring line and then insert an appropriate cut metal. However, it costs a lot of time and effort to comprehensively evaluate the crosstalk for a circuit to be designed.

In view of the above, the first embodiment describes a design support method of determining an arrangement position of a cut metal for decoupling capacitive coupling while focusing on the capacitive coupling formed by a metal wiring line (signal wiring line) used as a signal line through an adjacent floating wiring line. Hereinafter, exemplary processing of the design support device 101 will be described.

(1) The design support device 101 obtains layout data related to a circuit to be designed. Here, the layout data related to the circuit to be designed is information in which logical connection between gates (elements) is complete, which is, for example, information in which each gate is arranged and the gates are connected on the basis of logical information. The layout data related to the circuit to be designed may be, for example, layout data after delay evaluation.

The delay evaluation is a process of verifying timing of the circuit to be designed. In the delay evaluation, for example, static timing analysis (STA) based on the layout data is performed, and it is evaluated whether a delay target is satisfied on the basis of the analysis result. In a case where the delay target is not satisfied, for example, correction of arrangement, wiring, and the like are performed, and the delay evaluation is performed again.

In the example of FIG. 1, it is assumed that layout data 110 related to the circuit to be designed is obtained. The layout data 110 is layout data related to the circuit to be designed after the delay evaluation, and is layout data in which a gate position, wiring between gates, and the like are corrected to satisfy the delay target.

(2) The design support device 101 identifies a signal wiring line of a multi-patterning wiring layer on the basis of the obtained layout data. Furthermore, the design support device 101 detects a floating wiring line adjacent to the identified signal wiring line and having a part parallel to the signal wiring line from the multi-patterning wiring layer.

Here, the signal wiring line to be identified is, for example, a signal wiring line for a target signal. The target signal is a signal to be processed, which may be optionally specified. For example, a signal with a severe delay, in other words, for example, a signal with a small slack that does not have a margin for the target frequency is specified as the target signal. The signal wiring line is a metal wiring line used as a signal line.

The multi-patterning wiring layer is a wiring layer in which the wiring is designed using the multi-patterning technology. Metal wiring lines (extended wiring lines) are spread over the multi-patterning wiring layer, and by arranging a cut metal (CM), for example, it becomes possible to divide the wiring part sandwiched between the cut metals as a signal wiring line. The multi-patterning wiring layer is applied to, for example, a wiring layer of a lower layer (first to third layers, etc.) required to be finer. The floating wiring line is a wiring part not used as a signal wiring line.

In the example of FIG. 1, it is assumed that a signal wiring line 121 of a multi-patterning wiring layer 120 is identified for the target signal on the basis of the layout data 110. In this case, the design support device 101 detects a floating wiring line 122 adjacent to the signal wiring line 121 and having a part parallel to the signal wiring line 121 from the multi-patterning wiring layer 120. Note that a wiring part indicated by a solid line indicates a signal wiring line in the multi-patterning wiring layer 120. Furthermore, a wiring part indicated by a dash-dotted line indicates a floating wiring line.

Here, the signal wiring line 121 is a part sandwiched between cut metals 131 and 132, and forms capacitive coupling with another signal wiring line 123 via the floating wiring line 122. However, in FIG. 1, a part of the multi-patterning wiring layer 120 is excerpted and displayed. Therefore, the signal wiring line 121 may form capacitive coupling with a signal wiring line in an area not illustrated in FIG. 1 via the floating wiring line 122.

(3) the design support device 101 determines an arrangement position of the cut metal for dividing the detected floating wiring line on the basis of the arrangement positions of the cut metals arranged at both ends of the identified signal wiring line. Specifically, for example, the design support device 101 determines positions on the floating wiring line facing the respective cut metals arranged at both ends of the identified signal wiring line as the arrangement positions of the cut metals for dividing the floating wiring line.

In the example of FIG. 1, the design support device 101 determines, for example, positions p1 and p2 (dotted frame in FIG. 1) on the floating wiring line 122 as the arrangement positions of the cut metals for dividing the floating wiring line 122. The position p1 is a position on the floating wiring line 122 facing the cut metal 131 arranged at one end of the signal wiring line 121. The position p2 is a position on the floating wiring line 122 facing the cut metal 132 arranged at the other end of the signal wiring line 121. For example, the design support device 101 determines the arrangement position of the cut metal in such a manner that the part of the floating wiring line 122 parallel to the signal wiring line 121 is divided to avoid capacitive coupling via the floating wiring line 122.

As described above, according to the design support device 101 according to the first embodiment, it becomes possible to determine the effective arrangement position of the cut metal for decoupling the capacitive coupling via the floating wiring line in the layout design using the multi-patterning technology. Furthermore, with the cut metal arranged at the arrangement position, it becomes possible to efficiently reduce the crosstalk noise.

In the example of FIG. 1, for example, when the cut metals are arranged at the respective determined positions p1 and p2, the floating wiring line 122 is divided into floating wiring lines 122-1, 122-2, and 122-3. Each of the floating wiring lines 122-1 and 122-3 has no part parallel to the signal wiring line 121. Therefore, it becomes possible to decouple the capacitive coupling via the floating wiring line on the left side of the position p1 and on the right side of the position p2, and to reduce the crosstalk noise.

Note that the process of arranging the cut metal at the determined arrangement position may be executed by a computer different from the design support device 101. For example, the design support device 101 may output information indicating the arrangement positions p1 and p2 of the cut metal for dividing the floating wiring line 122 in association with the layout data 110. With this arrangement, another computer is enabled to execute the process of arranging the cut metal for dividing the floating wiring line 122 by referring to the information indicating the arrangement positions p1 and p2 on the basis of the layout data 110.

### Second Embodiment

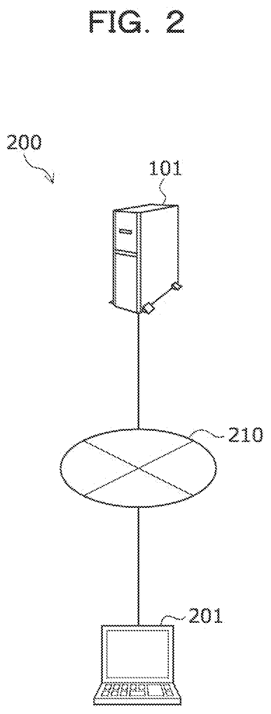

Next, a design support device 101 according to a second embodiment will be described. First, an exemplary system configuration of an information processing system 200 including the design support device 101 according to the second embodiment will be described with reference to FIG. 2. The information processing system 200 is applied to, for example, a service that performs additional processing on layout data to reduce crosstalk noise. Note that descriptions of portions similar to the portions described in the first embodiment will be omitted.

FIG. 2 is an explanatory diagram illustrating an exemplary system configuration of the information processing system 200. In FIG. 2, the information processing system 200 includes the design support device 101 and a client device 201. In the information processing system 200, the design support device 101 and the client device 201 are connected via a wired or wireless network 210. The network 210 is, for example, the Internet, a local area network (LAN), a wide area network (WAN), or the like.

Examples of the design support device 101 include a server. The client device 201 is a computer used by a user of the information processing system 200. Examples of the user include a designer of a semiconductor integrated circuit. Examples of the client device 201 include a personal computer (PC), a tablet PC, and the like.

Note that, although the design support device 101 and the client device 201 are separately provided here, it is not limited thereto. For example, the design support device 101 may be implemented by the client device 201. Furthermore, the information processing system 200 may include a plurality of the client devices 201.

(Exemplary Hardware Configuration of Design Support Device 101)

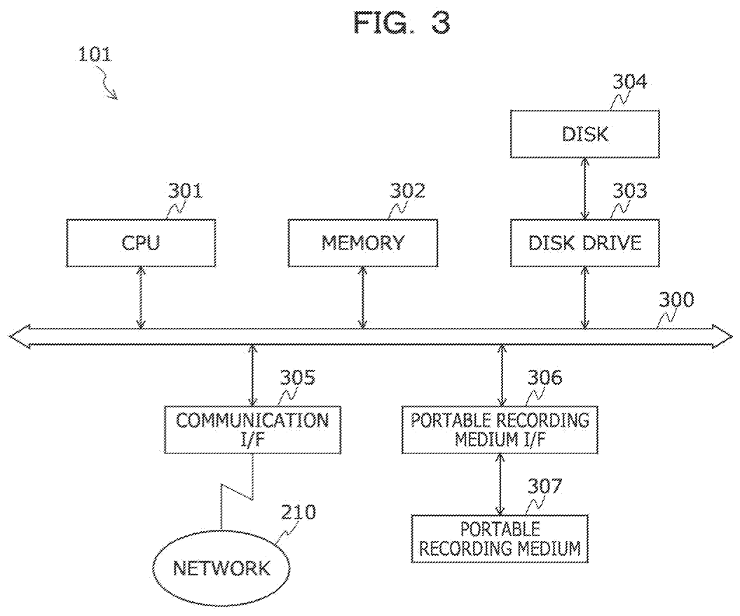

FIG. 3 is a block diagram illustrating an exemplary hardware configuration of the design support device 101. In FIG. 3, the design support device 101 includes a CPU 301, a memory 302, a disk drive 303, a disk 304, a communication interface (I/F) 305, a portable recording medium I/F 306, and a portable recording medium 307. Furthermore, the individual components are connected to each other by a bus 300.

Here, the CPU 301 performs overall control of the design support device 101. The CPU 301 may include a plurality of cores. The memory 302 includes, for example, a read only memory (ROM), a random access memory (RAM), a flash ROM, and the like. Specifically, for example, the flash ROM stores an operating system (OS) program, the ROM stores application programs, and the RAM is used as a work area for the CPU 301. The programs stored in the memory 302 are loaded into the CPU 301 to cause the CPU 301 to execute coded processing.

The disk drive 303 controls reading and writing of data from and into the disk 304 under the control of the CPU 301. The disk 304 stores data written under the control of the disk drive 303. Examples of the disk 304 include a magnetic disk, an optical disk, and the like.

The communication I/F 305 is connected to the network 210 through a communication line, and is connected to an external computer (e.g., client device 201 illustrated in FIG. 2) via the network 210. Then, the communication I/F 305 manages an interface between the network 210 and the inside of the device, and controls input and output of data from an external computer. For example, a modem, a LAN adapter, or the like may be employed as the communication I/F 305.

The portable recording medium I/F 306 controls reading and writing of data from and into the portable recording medium 307 under the control of the CPU 301. The portable recording medium 307 stores data written under the control of the portable recording medium I/F 306. Examples of the portable recording medium 307 include a compact disc (CD)-ROM, a digital versatile disk (DVD), a universal serial bus (USB) memory, and the like.

Note that the design support device 101 may include, for example, an input device, a display, and the like in addition to the components described above. Furthermore, the client device 201 illustrated in FIG. 2 may be implemented by a hardware configuration similar to that of the design support device 101. However, the client device 201 includes, for example, an input device, a display, and the like in addition to the components described above.

(Exemplary Functional Configuration of Design Support Device 101)

Next, an exemplary functional configuration of the design support device 101 according to the second embodiment will be described.

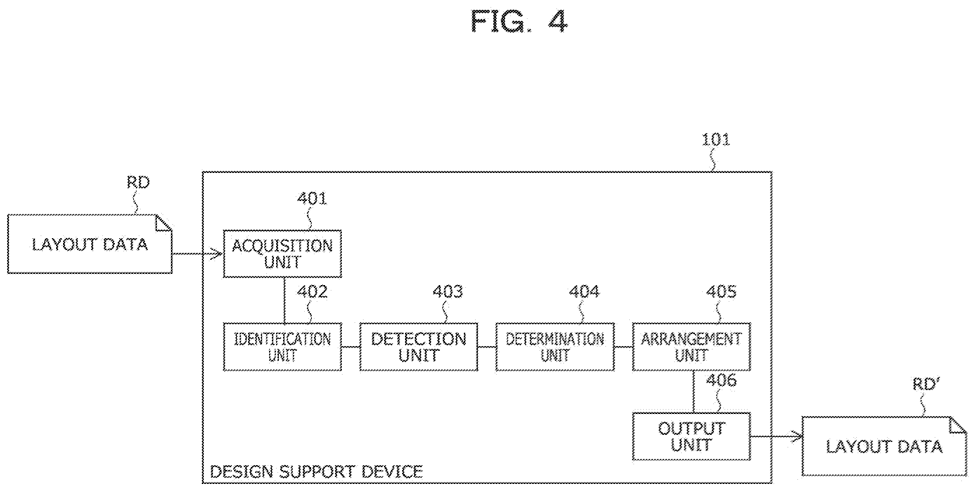

FIG. 4 is a block diagram illustrating an exemplary functional configuration of the design support device 101. In FIG. 4, the design support device 101 includes an acquisition unit 401, an identification unit 402, a detection unit 403, a determination unit 404, an arrangement unit 405, and an output unit 406. The acquisition unit 401 to output unit 406 have functions serving as a control unit, and specifically, for example, those functions are implemented by the program stored in a storage device such as the memory 302, disk 304, or portable recording medium 307 illustrated in FIG. 3 executed by the CPU 301 or by the communication I/F 305. A processing result of each functional unit is stored in, for example, a storage device such as the memory 302 or the disk 304.

The acquisition unit 401 obtains layout data RD related to the circuit to be designed. The layout data RD is information in which logical connection between gates is complete, which is, for example, layout data after the delay evaluation for the circuit to be designed. Furthermore, the acquisition unit 401 may obtain a delay evaluation result (STA result) related to the circuit to be designed together with the layout data RD. The delay evaluation result indicates a delay value, which is a result of the STA, in association with a signal name of the circuit to be designed, for example.

Specifically, for example, the acquisition unit 401 obtains the layout data RD and the delay evaluation result by reception from the client device 201 illustrated in FIG. 2. Furthermore, the acquisition unit 401 may obtain the layout data RD and the delay evaluation result by operation input by the user using an input device (not illustrated).

The identification unit 402 identifies a signal wiring line of a multi-patterning wiring layer for a target signal on the basis of the layout data RD related to the circuit to be designed. Specifically, for example, first, the identification unit 402 selects the target signal (signal to be processed) from the signals in the circuit to be designed. For example, the identification unit 402 may select a signal specified in advance as a target signal. The specification of the target signal is received from, for example, the client device 201.

A signal with a severe delay is likely to take an erroneous value into a sequential circuit due to crosstalk noise. Therefore, the identification unit 402 may select signals in descending order of delay severity as target signals by referring to the delay evaluation result related to the circuit to be designed, for example. At this time, the number of signals to be processed may be limited according to the delay severity. For example, the identification unit 402 may select, as target signals, signals having a delay value equal to or higher than a threshold value in descending order of delay severity by referring to the delay evaluation result.

Next, the identification unit 402 identifies a signal wiring line of the multi-patterning wiring layer for the selected target signal on the basis of the obtained layout data RD. More specifically, for example, the identification unit 402 identifies, as a signal wiring line, a wiring part sandwiched between cut metals, which is a wiring part in which a via is arranged, for each multi-patterning wiring layer forming the signal wiring line. The via connects between different wiring layers.

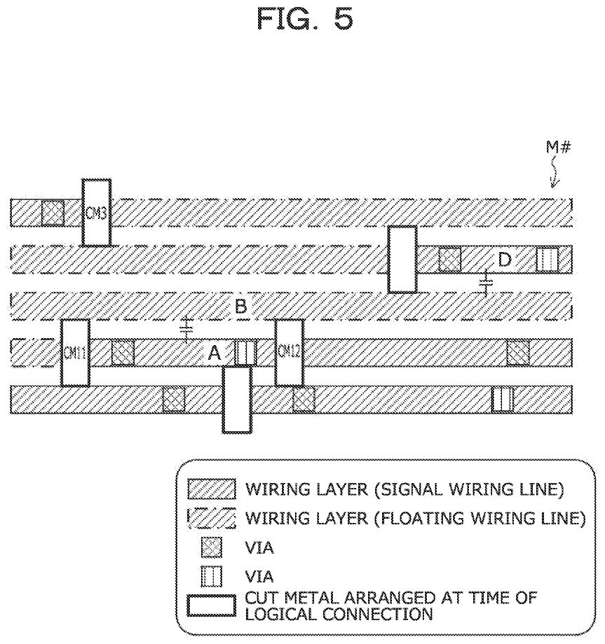

An example of identification of the signal wiring line will be described later with reference to FIG. 5.

Note that the layout data RD may include attribute information for specifying, for each wiring line, whether it is a signal wiring line or a floating wiring line. In this case, the identification unit 402 may refer to the attribute information for each wiring line to identify the signal wiring line of the multi-patterning wiring layer for the selected target signal.

In the following descriptions, the signal wiring line of the multi-patterning wiring layer identified for the target signal may be referred to as a “wiring line of concern”.

The detection unit 403 detects, on the basis of the obtained layout data RD, the floating wiring line adjacent to the identified wiring line of concern and having a part parallel to the wiring line of concern from the multi-patterning wiring layer. Specifically, for example, the detection unit 403 sets a predetermined search range AR in the wiring direction adjacent to the wiring line of concern in the multi-patterning wiring layer with reference to the wiring line of concern.

Here, the search range AR may be set optionally. The search range AR is set on the basis of the inter-wiring distance and the wiring width of the circuit to be designed, for example. More specifically, for example, the detection unit 403 sets a figure in which the wiring line of concern is widened on both sides in the adjacent wiring direction by “inter-wiring distance*1.5+wiring width” as the search range.

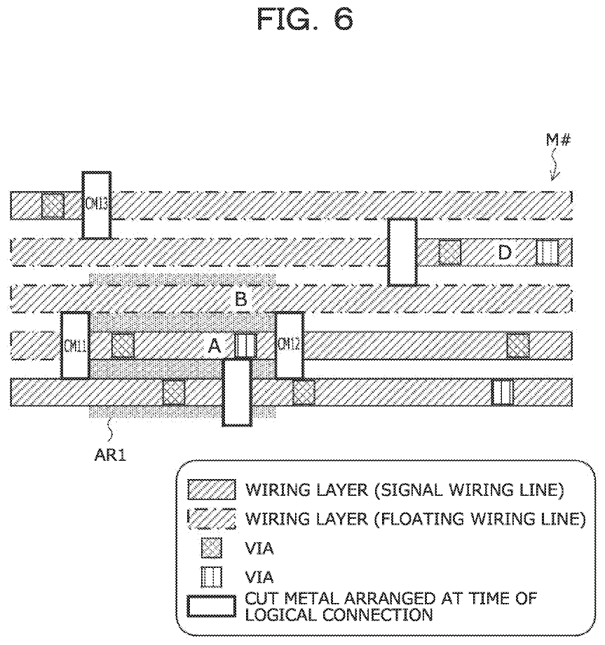

An example of setting of the search range AR will be described later with reference to FIG. 6.

Then, the detection unit 403 detects a floating wiring line that overlaps with the set search range AR. More specifically, for example, the detection unit 403 refers to the layout data RD and detects a wiring line that partially or completely overlaps with the search range AR. Next, the detection unit 403 determines whether or not the detected wiring line is a floating wiring line.

For example, in a case where the detected wiring line is a wiring part used as a signal wiring line, the detection unit 403 determines that it is not a floating wiring line. On the other hand, in a case where the detected wiring line is a wiring part not used as a signal wiring line, the detection unit 403 determines that it is a floating wiring line and detects the wiring line as a floating wiring line.

An example of detection of the floating wiring line will be described later with reference to FIG. 6.

The determination unit 404 determines an arrangement position of the cut metal for dividing the detected floating wiring line on the basis of the arrangement positions of the cut metals arranged at both ends of the wiring line of concern. The arrangement positions of the cut metals arranged at both ends of the wiring line of concern are specified from the layout data RD. Specifically, for example, the determination unit 404 may determine positions on the floating wiring line facing the respective cut metals arranged at both ends of the wiring line of concern to be the arrangement position of the cut metal for dividing the floating wiring line.

For example, it is assumed that the cut metals arranged at both ends of the wiring line of concern are rectangular objects arranged to be orthogonal to the wiring line of concern. In this case, the determination unit 404 may determine positions on the extension of the respective cut metals arranged at both ends of the wiring line of concern on the detected floating wiring line to be arrangement positions of the cut metals for dividing the floating wiring line.

For example, the determination unit 404 specifies a position on the extension of the cut metal arranged at one end of the wiring line of concern and a position on the extension of the cut metal arranged at the other end of the wiring line of concern on the floating wiring line. Then, the determination unit 404 determines each of the specified positions as the arrangement position of the cut metal for dividing the floating wiring line.

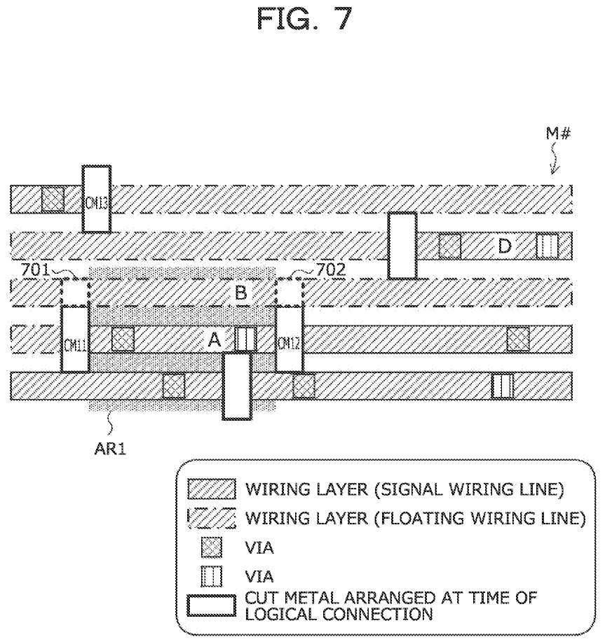

An example of determination of the arrangement position of the cut metal will be described later with reference to FIG. 7.

The arrangement unit 405 arranges the cut metal at the determined arrangement position. Specifically, for example, the arrangement unit 405 may arrange a new cut metal at each of the determined arrangement positions in the obtained layout data RD. Furthermore, the arrangement unit 405 may extend, in the obtained layout data RD, the cut metals arranged at both ends of the wiring line of concern to the determined arrangement positions corresponding to the respective cut metals.

For example, it is assumed that, on the floating wiring line, a first position on the extension of the cut metal arranged at one end of the wiring line of concern and a second position on the extension of the cut metal arranged at the other end of the wiring line of concern are determined to be the arrangement positions of the cut metals for dividing the floating wiring line. In this case, the arrangement unit 405 may arrange a new cut metal at each of the first position and the second position. Furthermore, the arrangement unit 405 may extend the cut metal arranged at one end of the wiring line of concern to the first position, and may extend the cut metal arranged at the other end of the wiring line of concern to the second position. For example, instead of arranging the cut metal separately, the cut metals at both ends of the wiring line of concern may be extended until the detected floating wiring line is divided.

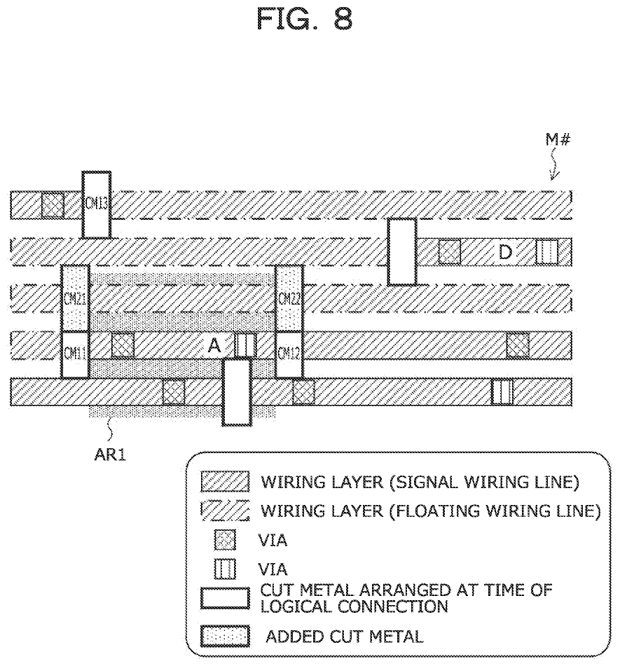

An example of arrangement of the new cut metal will be described later with reference to FIG. 8.

Furthermore, the arrangement unit 405 may determine whether or not the cut metal arranged at the determined arrangement position satisfies a design rule of the circuit to be designed. The design rule indicates constraints to be met at a time of designing a circuit. Examples of the constraints include the minimum width of a line, the minimum spacing between lines, the minimum width of margin in a case of overlaying figures, and the like.

Here, in a case of not satisfying the design rule, the arrangement unit 405 may correct the arrangement position of the arranged cut metal to any position on the floating wiring line in such a manner that the design rule is satisfied and the distance between the positions before and after the correction is minimized.

Specifically, for example, in a case where the design rule is not satisfied with respect to the cut metal arranged at the first position on the floating wiring line, the arrangement unit 405 corrects the arrangement position of the cut metal to a position at which a moving distance is the minimum width that satisfies the design rule with reference to the first position.

Furthermore, in a case where the design rule is not satisfied with respect to the cut metal arranged at the second position on the floating wiring line, the arrangement unit 405 corrects the arrangement position of the cut metal to a position at which a moving distance is the minimum width that satisfies the design rule with reference to the second position.

Furthermore, at the time of correcting the arrangement positions of the cut metals arranged at the first position and the second position, the arrangement unit 405 may move the cut metals in such a manner that the wiring part divided by the cut metals on the floating wiring line is not reduced. With this arrangement, it becomes possible to correct the arrangement position of the cut metal in such a manner that the wiring part on the floating wiring line parallel to the wiring line of concern is not reduced.

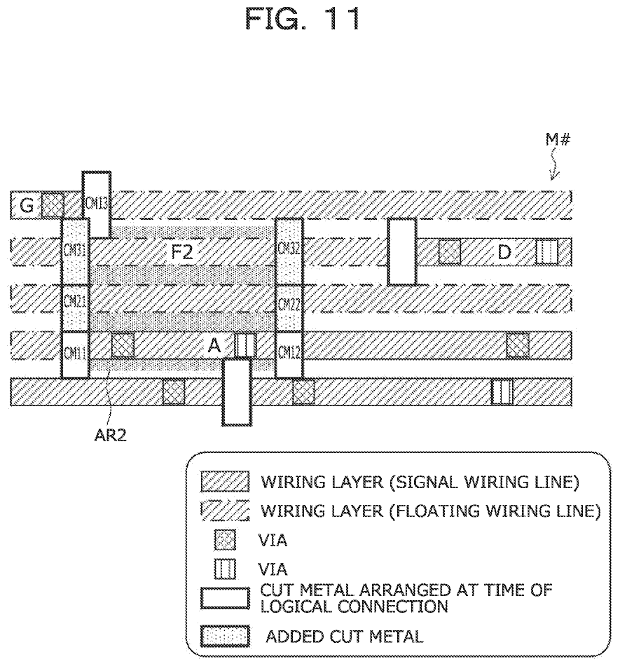

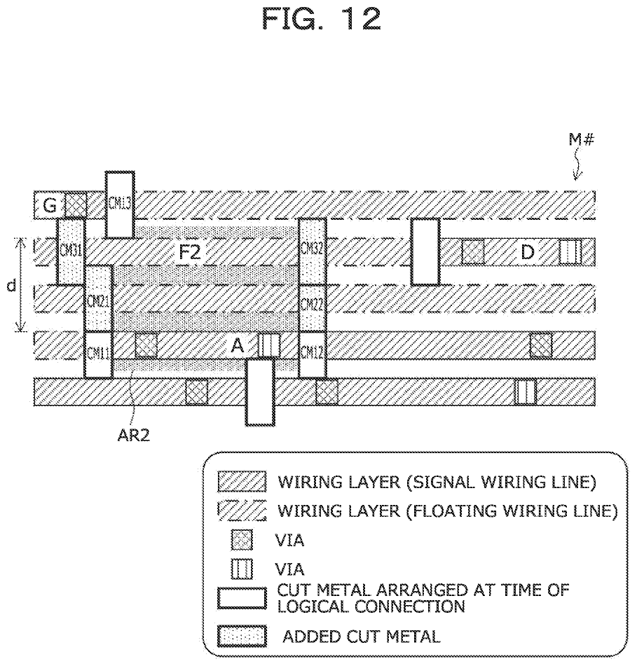

An example of correction of the arrangement position of the cut metal will be described later with reference to FIGS. 11 and 12.

Note that it is assumed that the design rule is violated in a case where the floating wiring line is divided by extending the cut metals at both ends of the wiring line of concern instead of arranging the cut metal separately. In this case, for example, the arrangement unit 405 returns the cut metals at both ends of the wiring line of concern to the state before the extension, and arranges a new cut metal on the floating wiring line, thereby making correction.

Furthermore, the detection unit 403 may refer to the wiring part sandwiched between the arranged cut metals in the detected floating wiring line in the multi-patterning wiring layer to set the search range AR in the wiring direction adjacent to the wiring part until the distance from the wiring line of concern to the detected floating wiring line becomes equal to or greater than a preset value. Then, the detection unit 403 may detect floating wiring line that overlaps with the set search range AR.

For example, in order to further reduce crosstalk noise, not only the immediately adjacent floating wiring line parallel to the wiring line of concern but also a plurality of floating wiring lines within a specified distance may be picked up to perform similar processing. The preset value may be set optionally, and is set in consideration of, for example, magnitude of the influence of the crosstalk noise and a processing time.

Furthermore, instead of picking up a floating wiring line two or more lines away from one wiring line of concern, a cut metal may be inserted into the immediately adjacent floating wiring line, and then the next adjacent floating wiring line parallel to that floating wiring line may be picked up to perform similar processing. In this case as well, the range of the wiring lines to be processed for the wiring line of concern is set in consideration of, for example, the magnitude of the influence of the crosstalk noise and the processing time.

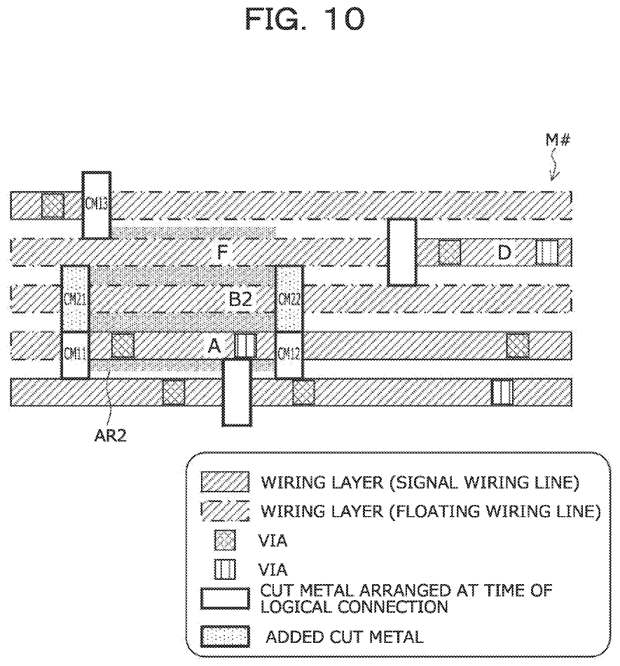

An example of setting of the search range AR set with reference to the wiring part sandwiched between the cut metals arranged on the floating wiring line will be described later with reference to FIG. 10.

The output unit 406 outputs corrected layout data RD′. Here, the corrected layout data RD′ is the layout data RD in which the cut metal is arranged at the determined arrangement position. Examples of an output format of the output unit 406 include storage to a storage device such as the memory 302 or the disk 304, transmission to another computer using the communication I/F 305, and the like.

Furthermore, the output unit 406 may output information indicating the determined arrangement position of the cut metal in association with the layout data RD. With this arrangement, another computer (e.g., client device 201) is enabled to execute the process of arranging the cut metal for dividing the floating wiring line by referring to the information indicating the determined arrangement position of the cut metal on the basis of the layout data RD.

Note that the functional units (acquisition unit 401 to output unit 406) of the design support device 101 described above may be implemented by a plurality of computers (e.g., design support device 101 and client device 201) in the information processing system 200.

(Exemplary Operation of Design Support Device 101)

Next, exemplary operation of the design support device 101 according to the second embodiment will be described with reference to FIGS. 5 to 12. Here, a case in which a signal with a severe delay in the delay evaluation result is set as a target signal for the layout data RD after the logical connection is complete will be described.

FIGS. 5 to 12 are explanatory diagrams illustrating exemplary operations of the design support device 101 according to the second embodiment. In FIG. 5, a multi-patterning wiring layer M # is an exemplary wiring layer including a signal wiring line of a target signal. However, in FIGS. 5 to 12, a part of the multi-patterning wiring layer M # is excerpted and displayed. For example, for the multi-patterning wiring layer M #, only wiring lines extending in the horizontal direction (right-left direction) in the drawing are illustrated, and wiring lines extending in the vertical direction (top-down direction) are omitted.

Metal wiring lines are spread over the multi-patterning wiring layer M #, and it is possible to divide the wiring part to be used for a signal wiring line or the like by arranging the cut metal. The cut metal is a rectangular object to be arranged to be orthogonal to the wiring line. A wiring part indicated by a solid line indicates a signal wiring line in the multi-patterning wiring layer M #. Furthermore, a wiring part indicated by a dash-dotted line indicates a floating wiring line. Patterned squares on the wiring indicate vias. White rectangular cut metals represent cut metals arranged at the time of logical connection.

Here, it is assumed that a wiring line of concern A is identified as a signal wiring line of the target signal. The wiring line of concern A is a wiring part sandwiched between cut metals CM11 and CM12, and forms capacitive coupling with another signal wiring line D via an adjacent floating wiring line B. However, the wiring line of concern A may form capacitive coupling with a signal wiring line in an area not illustrated in FIG. 5 via the floating wiring line B.

In FIG. 6, the detection unit 403 sets a search range AR1 in the multi-patterning wiring layer M # in the wiring direction (top-down direction in the drawing) adjacent to the wiring line of concern A with reference to the wiring line of concern A. The search range AR1 is a figure in which the wiring line of concern A is widened on both sides in the adjacent wiring direction by “inter-wiring distance*1.5+wiring width”.

The detection unit 403 detects a floating wiring line that overlaps with the set search range AR1. Here, it is assumed that the floating wiring line B is detected. Note that the processing for the wiring line of concern A is terminated in a case where there is no floating wiring line that overlaps with the search range AR1.

In FIG. 7, the determination unit 404 determines an arrangement position of the cut metal for dividing the detected floating wiring line B on the basis of the arrangement positions of the cut metals CM11 and CM12 arranged at both ends of the wiring line of concern A. The arrangement positions of the cut metals CM11 and CM12 arranged at both ends of the wiring line of concern A are specified from the layout data RD.

Here, the determination unit 404 determines a position 701 on the extension of the cut metal CM11 arranged at one end of the wiring line of concern A on the floating wiring line B as an arrangement position of the cut metal for dividing the floating wiring line B. Furthermore, the determination unit 404 determines a position 702 on the extension of the cut metal CM12 arranged at the other end of the wiring line of concern A as an arrangement position of the cut metal for dividing the floating wiring line B.

In FIG. 8, the arrangement unit 405 arranges a new cut metal at the determined arrangement position. Here, a cut metal CM21 is arranged at the position 701 on the extension of the cut metal CM11, and a cut metal CM22 is arranged at the position 702 on the extension of the cut metal CM12.

The size of the cut metals CM21 and CM22 to be newly arranged is set to a size that does not overlap with another wiring line while dividing the floating wiring line B. Note that, instead of arranging a new cut metal, the arrangement unit 405 may extend the positions of the respective cut metals CM11 and CM12 arranged at both ends of the wiring line of concern A to positions on the floating wiring line B facing the respective cut metals CM11 and CM12.

Furthermore, the arrangement unit 405 determines whether or not the arranged cut metals CM21 and CM22 satisfy the design rule of the circuit to be designed. Here, it is assumed that the design rule is satisfied with respect to the cut metals CM21 and CM22. Note that the arrangement positions of the cut metals CM21 and CM22 are corrected in a case where the design rule is not satisfied.

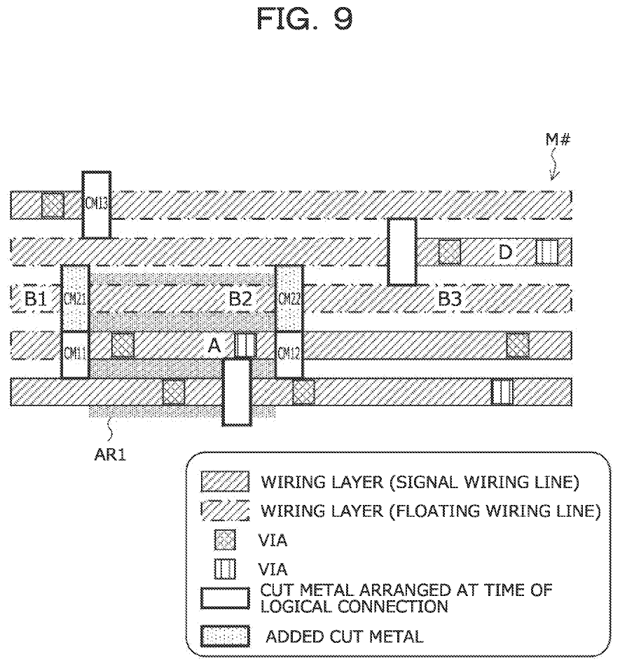

In FIG. 9, with the cut metals CM21 and CM22 arranged, the floating wiring line B is divided into floating wiring lines B1, B2, and B3. The floating wiring lines B1 and B3 do not have a portion parallel to the wiring line of concern A. Therefore, it becomes possible to decouple the capacitive coupling via the floating wiring line on the left side of the cut metal CM21 and on the right side of the cut metal CM22, and to reduce the crosstalk noise.

In FIG. 10, the detection unit 403 sets a search range AR2 in the multi-patterning wiring layer M # in the wiring direction (top-down direction in the drawing) adjacent to the floating wiring line B2 with reference to the floating wiring line B2. The search range AR2 is a figure in which the floating wiring line B2 is widened on both sides in the adjacent wiring direction by “inter-wiring distance*1.5+wiring width”.

The detection unit 403 detects a floating wiring line that overlaps with the set search range AR2. Here, it is assumed that a floating wiring line F is detected. Note that the processing for the wiring line of concern A is terminated in a case where there is no floating wiring line that overlaps with the search range AR2.

In FIG. 11, the determination unit 404 determines an arrangement position of the cut metal for dividing the detected floating wiring line F (see FIG. 10) on the basis of the arrangement positions of the cut metals CM11 and CM12 arranged at both ends of the wiring line of concern A. Here, the determination unit 404 determines a position on the extension of the cut metal CM11 arranged at one end of the wiring line of concern A on the floating wiring line F as an arrangement position of the cut metal for dividing the floating wiring line F.

Furthermore, the determination unit 404 determines a position on the extension of the cut metal CM12 arranged at the other end of the wiring line of concern A as an arrangement position of the cut metal for dividing the floating wiring line F. Then, the arrangement unit 405 arranges a new cut metal at the determined arrangement position. Here, a cut metal CM31 is arranged at the position on the extension of the cut metal CM11, and a cut metal CM32 is arranged at the position on the extension of the cut metal CM12. With the cut metals CM31 and CM32 arranged, a floating wiring line F2 is separated from the floating wiring line F.

Furthermore, the arrangement unit 405 determines whether or not the arranged cut metals CM31 and CM32 satisfy the design rule of the circuit to be designed. Here, it is assumed that, of the cut metals CM31 and CM32, the cut metal CM31 violates the design rule with respect to a position relative to a cut metal CM13 at one end of another signal wiring line G, and the design rule is not determined to be satisfied.

In FIG. 12, the arrangement unit 405 corrects the arrangement position of the cut metal CM31 to satisfy the design rule. The cut metal CM13 is one end of the existing signal wiring line G, which may deteriorate an evaluation result of the delay of the existing signal wiring line G or the like in a case of being moved, and it is not to be changed accordingly. Here, the arrangement position of the cut metal CM31 is corrected to a position at which the design rule is satisfied and the distance between the positions before and after the correction is minimized in such a manner that the wiring part of the floating wiring line F2 parallel to the wiring line of concern A is not reduced.

Here, in a case where the distance (e.g., distance d) from the wiring line of concern A to the detected floating wiring line F (see FIG. 10) is equal to or greater than a preset value, the processing for the wiring line of concern A is terminated. With this arrangement, the capacitive coupling between the wiring line of concern A and the signal wiring line D is decoupled without consideration for the signal wiring line D, and it becomes possible to reduce the influence of the crosstalk by the signal wiring line D.

(Design Support Processing Procedure of Design Support Device 101)

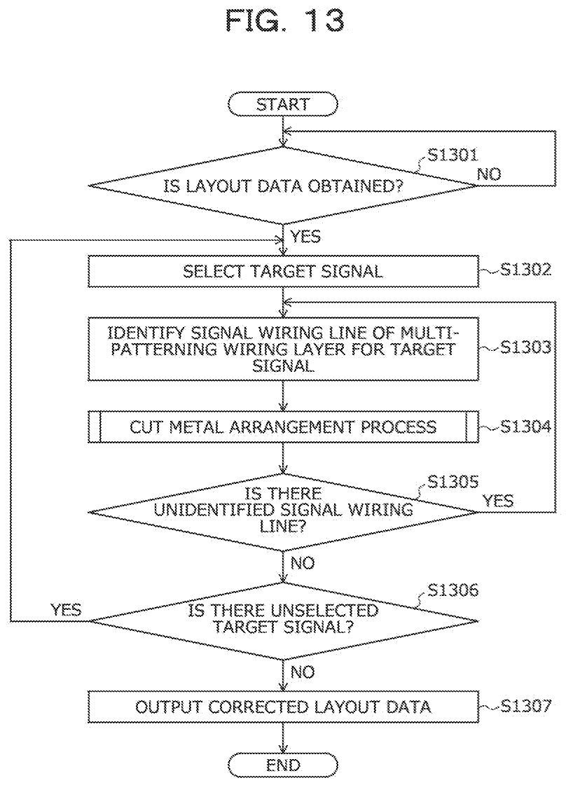

Next, a design support processing procedure of the design support device 101 according to the second embodiment will be described with reference to FIG. 13.

FIG. 13 is a flowchart illustrating an example of the design support processing procedure of the design support device 101 according to the second embodiment. In the flowchart of FIG. 13, first, the design support device 101 determines whether or not the layout data RD related to the circuit to be designed is obtained (step S1301).

Here, the design support device 101 waits for the layout data RD to be obtained (No in step S1301). Then, if the layout data RD is obtained (Yes in step S1301), the design support device 101 refers to a delay evaluation result (STA result) related to the circuit to be designed to select a target signal (step S1302).

Note that the delay evaluation result (STA result) is obtained together with the layout data RD in step S1301, for example. Furthermore, in step S1302, the design support device 101 may select signals in descending order of delay severity as target signals, or may limit the number of signals to be processed according to the delay severity.

Next, the design support device 101 identifies a signal wiring line of the multi-patterning wiring layer for the target signal on the basis of the obtained layout data RD (step S1303). Then, the design support device 101 executes a cut metal arrangement process related to the wiring line of concern, which is the identified signal wiring line (step S1304).

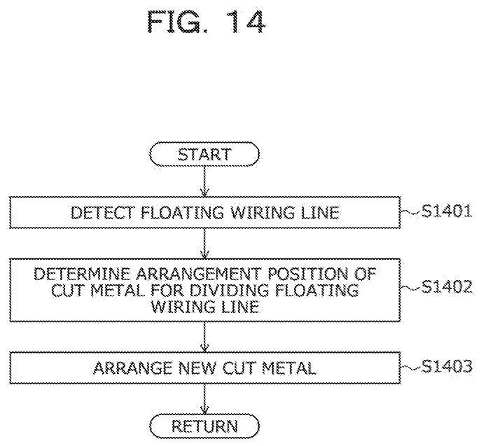

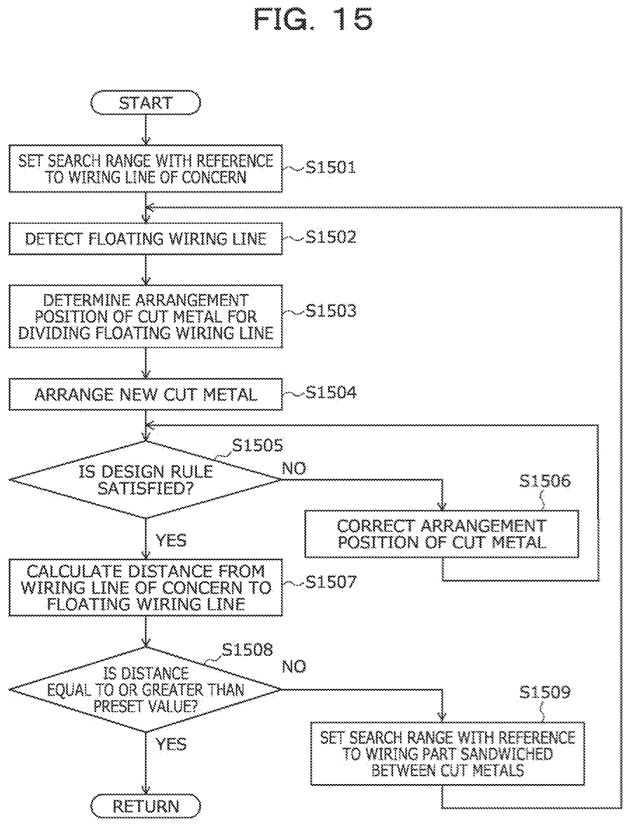

The cut metal arrangement process includes, for example, a first cut metal arrangement process and a second cut metal arrangement process. In step S1304, it may be optionally set as to which of the first and second cut metal arrangement processes is executed. A specific processing procedure of the first cut metal arrangement process will be described later with reference to FIG. 14. A specific processing procedure of the second cut metal arrangement process will be described later with reference to FIG. 15.

Next, the design support device 101 determines whether or not there is an unidentified signal wiring line in which the multi-patterning wiring layer is not identified for the target signal on the basis of the obtained layout data RD (step S1305). Here, if there is an unidentified signal wiring line (Yes in step S1305), the design support device 101 returns to step S1303.

On the other hand, if there is no unidentified signal wiring line (No in step S1305), the design support device 101 refers to the delay evaluation result related to the circuit to be designed to determine whether or not there is an unselected target signal that has not been selected (step S1306). Here, if there is an unselected target signal (Yes in step S1306), the design support device 101 returns to step S1302.

On the other hand, if there is no unselected target signal (No in step S1306), the design support device 101 outputs the corrected layout data RD′ (step S1307), and terminates the series of processes based on the present flowchart. The corrected layout data RD′ is layout data in which the cut metal is arranged at the determined arrangement position with respect to the layout data RD.

As a result, it becomes possible to avoid capacitive coupling via the floating wiring line adjacent to the signal wiring line (wiring line of concern), and to reduce the crosstalk noise.

Next, a specific processing procedure of the cut metal arrangement process in step S1304 will be described. Here, a case of arranging a new cut metal will be described as an example of the process of arranging the cut metal on the floating wiring line.

First, a specific processing procedure of the first cut metal arrangement process will be described with reference to FIG. 14. The first cut metal arrangement process is executed on the basis of the layout data RD obtained in step S1301.

FIG. 14 is a flowchart illustrating an example of the specific processing procedure of the first cut metal arrangement process. In the flowchart of FIG. 14, first, the design support device 101 detects a floating wiring line adjacent to the wiring line of concern and having a part parallel to the wiring line of concern from the multi-patterning wiring layer (step S1401).

Next, the design support device 101 determines an arrangement position of the cut metal for dividing the detected floating wiring line on the basis of the arrangement positions of the cut metals arranged at both ends of the wiring line of concern (step S1402). For example, the design support device 101 determines positions on the detected floating wiring line facing the respective cut metals arranged at both ends of the wiring line of concern as the arrangement positions of the cut metals for dividing the floating wiring line.

Then, the design support device 101 arranges a new cut metal at the determined arrangement position (step S1403), and returns to the step in which the first cut metal arrangement process is called.

As a result, it becomes possible to insert a cut metal efficiently in such a manner that capacitive coupling via the floating wiring line adjacent to the signal wiring line (wiring line of concern) is not formed.

Next, a specific processing procedure of the second cut metal arrangement process will be described with reference to FIG. 15. The second cut metal arrangement process is executed on the basis of the layout data RD obtained in step S1301.

FIG. 15 is a flowchart illustrating an example of the specific processing procedure of the second cut metal arrangement process. In the flowchart of FIG. 15, first, the design support device 101 sets the search range AR in the wiring direction adjacent to the wiring line of concern in the multi-patterning wiring layer with reference to the wiring line of concern (step S1501).

Next, the design support device 101 detects a floating wiring line that overlaps with the set search range AR (step S1502). Then, the design support device 101 determines an arrangement position of the cut metal for dividing the detected floating wiring line on the basis of the arrangement positions of the cut metals arranged at both ends of the wiring line of concern (step S1503).

For example, the design support device 101 determines positions on the detected floating wiring line facing the respective cut metals arranged at both ends of the wiring line of concern as the arrangement positions of the cut metals for dividing the floating wiring line. Next, the design support device 101 arranges a new cut metal at the determined arrangement position (step S1504).

Then, the design support device 101 determines whether or not the arranged cut metal satisfies the design rule of the circuit to be designed (step S1505). Here, if the design rule is not satisfied (No in step S1505), the design support device 101 corrects the arrangement position of the arranged cut metal (step S1506), and returns to step S1505. For example, the design support device 101 corrects the arrangement position of the arranged cut metal to any position on the floating wiring line in such a manner that the design rule is satisfied and the distance between the positions before and after the correction is minimized.

On the other hand, if the design rule is satisfied (Yes in step S1505), the design support device 101 calculates a distance from the wiring line of concern to the detected floating wiring line (step S1507). Then, the design support device 101 determines whether or not the calculated distance is equal to or greater than a preset value (step S1508).

Here, if the distance is less than the preset value (No in step S1508), the design support device 101 refers to the wiring part sandwiched between the arranged cut metals in the detected floating wiring line in the multi-patterning wiring layer to set the search range AR in the wiring direction adjacent to the wiring part (step S1509), and returns to step S1502.

On the other hand, if the distance is equal to or greater than the preset value (Yes in step S1508), the design support device 101 returns to the step in which the first cut metal arrangement process is called.

As a result, it becomes possible to pick up not only the immediately adjacent floating wiring line parallel to the wiring line of concern but also a plurality of floating wiring lines within a specified distance to insert the cut metal efficiently in order to further reduce crosstalk noise. Furthermore, it becomes possible to suppress violation of the design rule to avoid the crosstalk noise by checking the design rule each time a new cut metal is arranged.

As described above, according to the design support device 101 according to the second embodiment, it becomes possible to identify a signal wiring line of the multi-patterning wiring layer on the basis of the layout data RD related to the circuit to be designed, detect a floating wiring line adjacent to the identified signal wiring line (wiring line of concern) and having a part parallel to the wiring line of concern, and determine an arrangement position of the cut metal for dividing the detected floating wiring line on the basis of the arrangement positions of the cut metals arranged at both ends of the wiring line of concern.

With this arrangement, it becomes possible to determine the effective arrangement position of the cut metal for decoupling the capacitive coupling via the floating wiring line adjacent to the wiring line of concern in the layout design using the multi-patterning technology.

Furthermore, according to the design support device 101, it becomes possible to determine positions on the floating wiring line facing the respective cut metals arranged at both ends of the wiring line of concern as the arrangement positions of the cut metals for dividing the floating wiring line. For example, it is assumed that the cut metals arranged at both ends of the wiring line of concern are rectangular objects arranged to be orthogonal to the wiring line of concern. In this case, for example, the design support device 101 determines positions on the floating wiring line on the extension of the respective cut metals arranged at both ends of the wiring line of concern as the arrangement positions of the cut metals for dividing the floating wiring line.

With this arrangement, it becomes possible to determine the effective arrangement position of the cut metal for decoupling the capacitive coupling via the floating wiring line adjacent to the wiring line of concern.

Furthermore, according to the design support device 101, it becomes possible to arrange the cut metal at the determined arrangement position.

With this arrangement, it becomes possible to insert the cut metal at the effective position for decoupling the capacitive coupling via the floating wiring line adjacent to the wiring line of concern, and to reduce the crosstalk noise efficiently without consideration for another signal wiring line that forms capacitive coupling with the wiring line of concern.

Furthermore, according to the design support device 101, it becomes possible to arrange a new cut metal at each of the determined arrangement positions, or to extend the cut metals arranged at both ends of the wiring line of concern to the determined arrangement positions corresponding to the respective cut metals.

With this arrangement, it becomes possible to divide the floating wiring line by arranging a new cut metal or by using the cut metals already arranged at both ends of the wiring line of concern.

Furthermore, according to the design support device 101, it is determined whether or not the design rule of the circuit to be designed is satisfied with respect to the cut metal arranged at the determined arrangement position, and in a case where the design rule is not satisfied, it is possible to correct the arrangement position of the arranged cut metal to any position on the floating wiring line in such a manner that the design rule is satisfied and the distance between the positions before and after the correction is minimized.

With this arrangement, it becomes possible to suppress violation of the design rule to avoid the crosstalk noise by checking the design rule after the cut metal is arranged.

Furthermore, according to the design support device 101, it becomes possible to set the search range AR in the wiring direction adjacent to the wiring line of concern in the multi-patterning wiring layer with reference to the wiring line of concern, and to detect a floating wiring line that overlaps with the set search range AR. Furthermore, according to the design support device 101, it becomes possible to refer to the wiring part sandwiched between the arranged cut metals in the detected floating wiring line in the multi-patterning wiring layer to set the search range AR in the wiring direction adjacent to the wiring part until the distance from the wiring line of concern to the detected floating wiring line becomes equal to or greater than a preset value, and to detect a floating wiring line that overlaps with the set search range AR.

With this arrangement, it becomes possible to appropriately detect a floating wiring line that may affect the wiring line of concern at the time of suppressing the crosstalk noise. For example, it becomes possible to pick up not only the immediately adjacent floating wiring line parallel to the wiring line of concern but also a plurality of floating wiring lines within a specified distance to insert the cut metal efficiently in order to further reduce crosstalk noise.

Furthermore, according to the design support device 101, it becomes possible to set the search range AR on the basis of the inter-wiring distance and the wiring width of the circuit to be designed.

With this arrangement, it becomes possible to set a range in which the immediately adjacent floating wiring line parallel to the reference wiring line is detectable in the multi-patterning wiring layer.

Furthermore, according to the design support device 101, it becomes possible to output layout data RD (corrected layout data RD′) in which the cut metal is arranged at the determined arrangement position.

With this arrangement, it becomes possible to provide layout data in which the cut metal is inserted in such a manner that capacitive coupling via the floating wiring line adjacent to the wiring line of concern is not formed.

Furthermore, according to the design support device 101, it becomes possible to select a target signal on the basis of the delay evaluation result related to the circuit to be designed, identify a signal wiring line of the multi-patterning wiring layer for the selected target signal on the basis of the layout data RD after the delay evaluation related to the circuit to be designed, and detect a floating wiring line adjacent to the identified signal wiring line (wiring line of concern) and having a part parallel to the wiring line of concern from the multi-patterning wiring layer.

With this arrangement, it becomes possible to take measures against the crosstalk noise by giving priority to a signal with a severe delay, which is likely to take an erroneous value into the sequential circuit due to the crosstalk noise.

### Third Embodiment

Next, a design support device 101 according to a third embodiment will be described. The third embodiment describes a design support method of reducing crosstalk noise and delay by further adding a cut metal at a portion adjacent to a wiring line of concern on a floating wiring line adjacent to the wiring line of concern. Note that a part similar to the part described in the first and second embodiments is denoted by the same reference sign, and illustration and description thereof will be omitted.

(Exemplary Functional Configuration of Design Support Device 101)

First, an exemplary functional configuration of the design support device 101 according to the third embodiment will be described. However, the exemplary functional configuration of the design support device 101 according to the third embodiment is similar to the exemplary functional configuration of the design support device 101 according to the second embodiment, and thus illustration is omitted. Hereinafter, functions different from those of the design support device 101 according to the second embodiment will be described.

An arrangement unit 405 arranges one or a plurality of cut metals in a wiring part on the floating wiring line divided by a cut metal arranged at a determined arrangement position in such a manner that a design rule of a circuit to be designed is satisfied. With the cut metal added, the length of the wiring part adjacent to the wiring line of concern on the floating wiring line adjacent to the wiring line of concern is reduced by the width of the added cut metal, and coupling capacitance of the wiring line of concern is reduced.

Specifically, for example, the arrangement unit 405 may sequentially arrange cut metals in the wiring part in such a manner that the wiring part on the floating wiring line divided by the cut metal is equally divided. At this time, the arrangement unit 405 may add a cut metal while checking the design rule each time a cut metal is arranged to suppress violation of the design rule.

In a case where one or a plurality of cut metals is added, corrected layout data RD′ output by an output unit 406 is, for example, layout data RD in which cut metals are arranged at the determined arrangement positions and a cut metal is further added to the wiring part on the floating wiring line sandwiched between the cut metals.

(Exemplary Operation of Design Support Device 101)

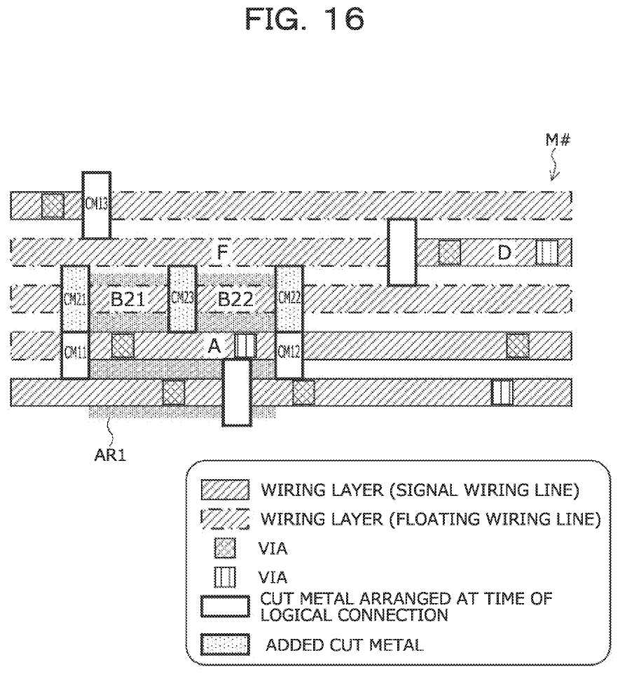

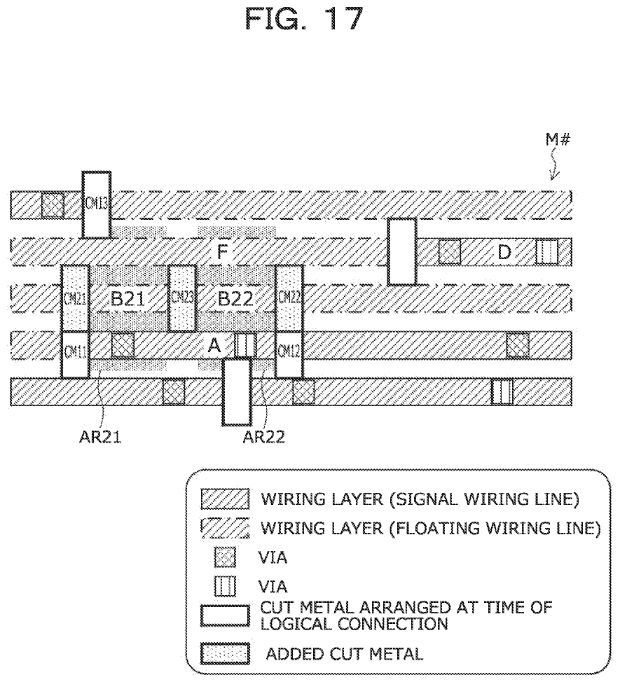

Next, exemplary operation of the design support device 101 according to the third embodiment will be described with reference to FIGS. 16 and 17. Here, using the wiring layout illustrated in FIG. 9 as an example, a case of adding a cut metal on a floating wiring line B2 (wiring part sandwiched between cut metals CM21 and CM22) adjacent to a wiring line of concern A will be described.

FIGS. 16 and 17 are explanatory diagrams illustrating exemplary operations of the design support device 101 according to the third embodiment. In FIG. 16, the arrangement unit 405 arranges one or a plurality of cut metals on the floating wiring line B2 in such a manner that the design rule is satisfied. The floating wiring line B2 is a wiring part divided by the cut metals CM21 and CM22 arranged on a floating wiring line B (see FIG. 6) adjacent to the wiring line of concern A.

Here, it is assumed that a cut metal CM23 is arranged on the floating wiring line B2. With the cut metal CM23 added, the floating wiring line B2 is divided into a floating wiring line B21 and a floating wiring line B22. With this arrangement, the length in which the wiring line of concern A and the floating wiring line B2 are adjacent to each other is reduced by the width of the added cut metal CM23, and the coupling capacitance of the wiring line of concern A is reduced.

For example, it becomes possible to reduce parasitic capacitance of a signal wiring line A of a target signal with a severe delay, whereby an effect of delay reduction is expected. Furthermore, since the coupling capacitance between a floating wiring line F and the floating wiring line B2 is also reduced, for example, it becomes possible to reduce the crosstalk noise of the wiring line of concern A via the floating wiring line B2 in a case where the floating wiring line F is another signal wiring line.

Furthermore, although the case of arranging one cut metal on the floating wiring line B2 has been described here, higher efficacy of reducing crosstalk noise may be expected when a larger number of cut metals are arranged within a range of satisfying the design rule. However, in a case where reduction of a delay of a signal having the wiring line of concern A raises a problem, that is, for example, in a case of racing, a cut metal may not be added.

In FIG. 17, in a case where the cut metal CM23 is arranged on the floating wiring line B2, a detection unit 403 sets search ranges AR21 and AR22 in a multi-patterning wiring layer M # in a wiring direction adjacent to the floating wiring lines B21 and B22 with reference to the floating wiring lines B21 and B22.

Specifically, for example, the detection unit 403 sets a figure in which the floating wiring line B21 is widened on both sides in the adjacent wiring direction by “inter-wiring distance*1.5+wiring width” as the search range AR21. Furthermore, the detection unit 403 sets a figure in which the floating wiring line B22 is widened on both sides in the adjacent wiring direction by “inter-wiring distance*1.5+wiring width” as the search range AR22.

Then, the detection unit 403 detects a floating wiring line that overlaps with the set search ranges AR21 and AR22. Subsequent processing is similar to the case of setting the search range AR2 (e.g., see FIG. 10) with reference to the floating wiring line B2, and thus illustration and description will be omitted.

(Design Support Processing Procedure of Design Support Device 101)

Next, a design support processing procedure of the design support device 101 according to the third embodiment will be described. However, among the design support processing procedures of the design support device 101 according to the third embodiment, processing procedures other than the cut metal arrangement process of step S1304 illustrated in FIG. 13 are similar to the design support processing procedures of the design support device 101 according to the second embodiment. Accordingly, a specific processing procedure of the cut metal arrangement process (third cut metal arrangement process) of the design support device 101 according to the third embodiment will be described.

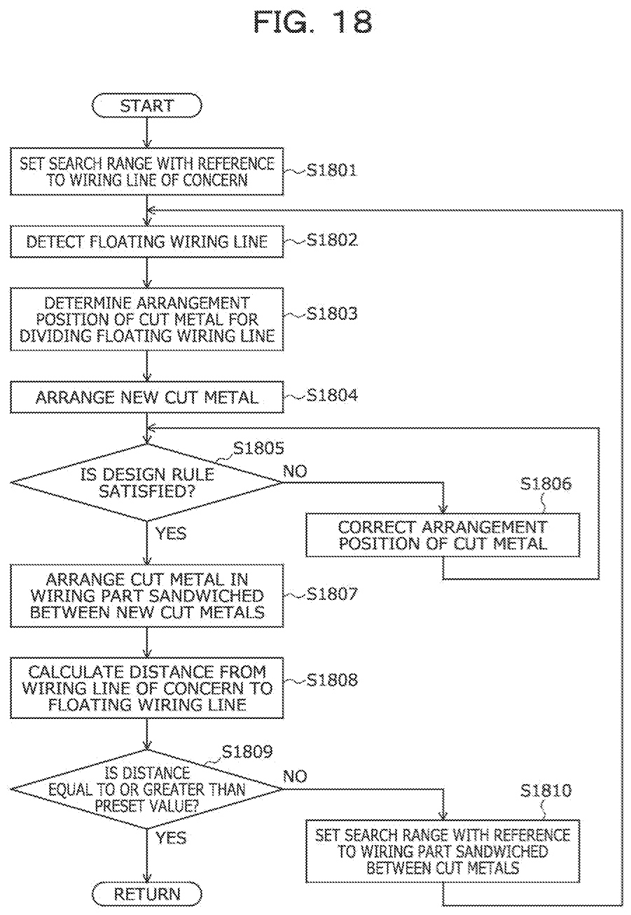

FIG. 18 is a flowchart illustrating an example of the specific processing procedure of the third cut metal arrangement process. In the flowchart of FIG. 18, first, the design support device 101 sets the search range AR in the wiring direction adjacent to the wiring line of concern in the multi-patterning wiring layer with reference to the wiring line of concern (step S1801).

Next, the design support device 101 detects a floating wiring line that overlaps with the set search range AR (step S1802). Then, the design support device 101 determines an arrangement position of the cut metal for dividing the detected floating wiring line on the basis of the arrangement positions of the cut metals arranged at both ends of the wiring line of concern (step S1803).

Next, the design support device 101 arranges a new cut metal at the determined arrangement position (step S1804). Then, the design support device 101 determines whether or not the arranged cut metal satisfies the design rule of the circuit to be designed (step S1805). Here, if the design rule is not satisfied (No in step S1805), the design support device 101 corrects the arrangement position of the arranged cut metal (step S1806), and returns to step S1805.

On the other hand, if the design rule is satisfied (Yes in step S1805), the design support device 101 arranges one or a plurality of cut metals in the wiring part sandwiched between the new cut metals arranged on the floating wiring line in such a manner that the design rule is satisfied (step S1807).

Next, the design support device 101 calculates a distance from the wiring line of concern to the detected floating wiring line (step S1808). Then, the design support device 101 determines whether or not the calculated distance is equal to or greater than a preset value (step S1809).

Here, if the distance is less than the preset value (No in step S1809), the design support device 101 refers to each wiring part sandwiched between the arranged cut metals in the detected floating wiring line in the multi-patterning wiring layer to set the search range AR in the wiring direction adjacent to the wiring part (step S1810), and returns to step S1802.

On the other hand, if the distance is equal to or greater than the preset value (Yes in step S1809), the design support device 101 returns to the step in which the first cut metal arrangement process is called.

As a result, it becomes possible to further add a cut metal at a position adjacent to the wiring line of concern on the floating wiring line adjacent to the wiring line of concern.

As described above, according to the design support device 101 according to the third embodiment, it becomes possible to arrange one or a plurality of cut metals in the wiring part on the floating wiring line divided by the arranged cut metal in such a manner that the design rule of the circuit to be designed is satisfied.

With this arrangement, it becomes possible to reduce the length in which the wiring line of concern and the floating wiring line are adjacent to each other by the width of the added cut metal, and to reduce the coupling capacitance of the wiring line of concern. As a result, for example, it becomes possible to reduce parasitic capacitance of a signal wiring line of a target signal with a severe delay, and to reduce the delay. Furthermore, it also becomes possible to reduce the crosstalk noise of the wiring line of concern via the floating wiring line in a case where the floating wiring line is adjacent to another signal wiring line.

### Fourth Embodiment

Next, a design support device 101 according to a fourth embodiment will be described. The fourth embodiment describes a case of setting a permissible range in which a cut metal may be arranged on a floating wiring line adjacent to a wiring line of concern. Note that a part similar to the part described in the first to third embodiments is denoted by the same reference sign, and illustration and description thereof will be omitted.

(Exemplary Functional Configuration of Design Support Device 101)

First, an exemplary functional configuration of the design support device 101 according to the fourth embodiment will be described. However, the exemplary functional configuration of the design support device 101 according to the fourth embodiment is similar to the exemplary functional configuration of the design support device 101 according to the second embodiment, and thus illustration is omitted. Hereinafter, functions different from those of the design support device 101 according to the second embodiment will be described.

At a time of determining an arrangement position of a cut metal for dividing a detected floating wiring line, a determination unit 404 sets a permissible range for cut metal arrangement on the floating wiring line. Specifically, for example, the determination unit 404 sets a permissible range for cut metal arrangement on the floating wiring line with reference to positions on the floating wiring line facing the respective cut metals arranged at both ends of the wiring line of concern.

The permissible range for cut metal arrangement may be optionally set, and for example, it is set on the basis of a permissible capacitance value between adjacent wiring lines. Specifically, for example, the determination unit 404 determines a threshold value of the capacitance value between adjacent wiring lines to which the influence of noise may be tolerated in advance, and calculates a length L1 of the adjacent wiring line that is equal to or less than the capacitance value.

Here, exemplary calculation of the length L1 will be described. First, the determination unit 404 measures a noise amount N_{X} and an inter-wiring capacitance value C_{X} between an output wiring line of a gate such as INV, NAND and an adjacent wiring line having a parallel wiring length of Lx by simulation. Next, for example, the determination unit 404 uses the following equation (1) and a noise limit value N_{L} determined by the chip design to obtain a threshold value C_{L} of the capacitance value between adjacent wiring lines that satisfies the noise limit value N_{L} from the measurement result of the noise amount N_{X} and inter-wiring capacitance value C_{X}. The threshold value C_{L} is used for measures against noise at the time of connection of gates, for example.

$${C}_{L} = \frac{{N}_{L}}{{N}_{X}} \times {C}_{X} \qquad ( 1 )$$

Here, the noise amount that may be tolerated to exert influence is set to 1/10 of the noise limit value. Since a wiring width and an inter-wiring distance are fixed in the multi-patterning wiring layer, the parallel wiring length and the capacitance value between wiring lines are proportional to each other. Accordingly, it is possible to obtain the length L1 of the adjacent wiring length that may tolerate the influence of noise using the following equation (2).

$$L 1 = \frac{\frac{1}{10} {C}_{L}}{{C}_{X}} \times {L}_{X} \qquad ( 2 )$$

The determination unit 404 sets a range widened on both sides in the wiring direction by the calculated length L1 as a permissible range for arrangement with reference to positions on the floating wiring line facing the respective cut metals arranged on both ends of the wiring line of concern. Then, the determination unit 404 determines any position within the set permissible range for arrangement as the arrangement position of the cut metal for dividing the floating wiring line.

Specifically, for example, the determination unit 404 determines any position within the permissible range for arrangement as the arrangement position of the cut metal in such a manner that the design rule of the circuit to be designed is satisfied. More specifically, for example, the determination unit 404 may determine any position within the permissible range for arrangement in such a manner that the design rule is satisfied and the distance from the reference position is minimized.

Note that the determination unit 404 may set the permissible range for cut metal arrangement on the floating wiring line in a case where it is not possible to arrange cut metals at the positions on the floating wiring line facing the cut metals arranged at both ends of the wiring line of concern, for example.

(Exemplary Operation of Design Support Device 101)

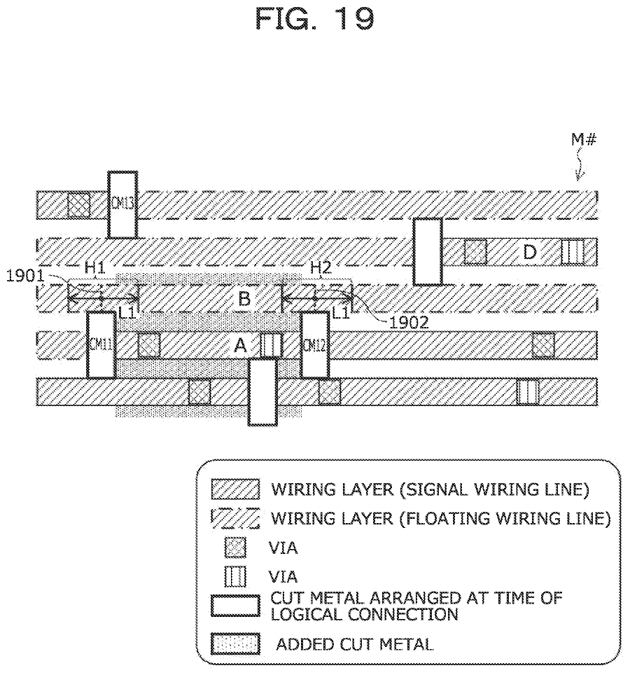

Next, exemplary operation of the design support device 101 according to the fourth embodiment will be described with reference to FIGS. 19 to 21. Here, using the wiring layout illustrated in FIG. 6 as an example, a case of setting a permissible range for cut metal arrangement on a floating wiring line B adjacent to a wiring line of concern A will be described.

FIGS. 19 to 21 are explanatory diagrams illustrating exemplary operations of the design support device 101 according to the fourth embodiment. In FIG. 19, the determination unit 404 uses, as a reference, positions 1901 and 1902 on the floating wiring line B facing respective cut metals CM11 and CM12 arranged at both ends of the wiring line of concern A.

Then, the determination unit 404 sets a permissible range for cut metal arrangement on the floating wiring line B with reference to the positions 1901 and 1902 on the floating wiring line B. Specifically, for example, the determination unit 404 sets a range H1 widened on both sides in the wiring direction by the length L1 as a permissible range for arrangement with reference to the position 1901 on the floating wiring line B. Furthermore, the determination unit 404 sets a range H2 widened on both sides in the wiring direction by the length L1 as a permissible range for arrangement with reference to the position 1902 on the floating wiring line B.

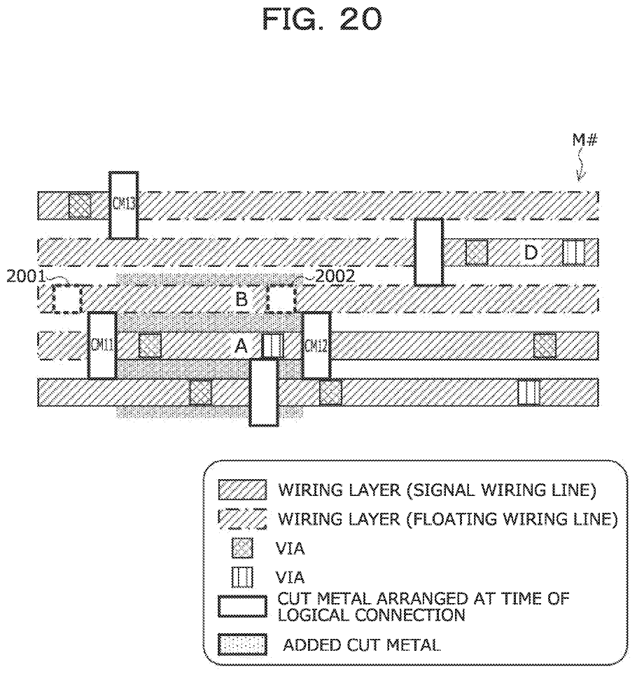

In FIG. 20, the determination unit 404 determines any position within each of the set permissible ranges for arrangement H1 and H2 as the arrangement position of the cut metal for dividing the floating wiring line B. Here, it is assumed that a position 2001 within the permissible range for arrangement H1 and a position 2002 within the permissible range for arrangement H2, which satisfy the design rule, are determined as arrangement positions of cut metals.

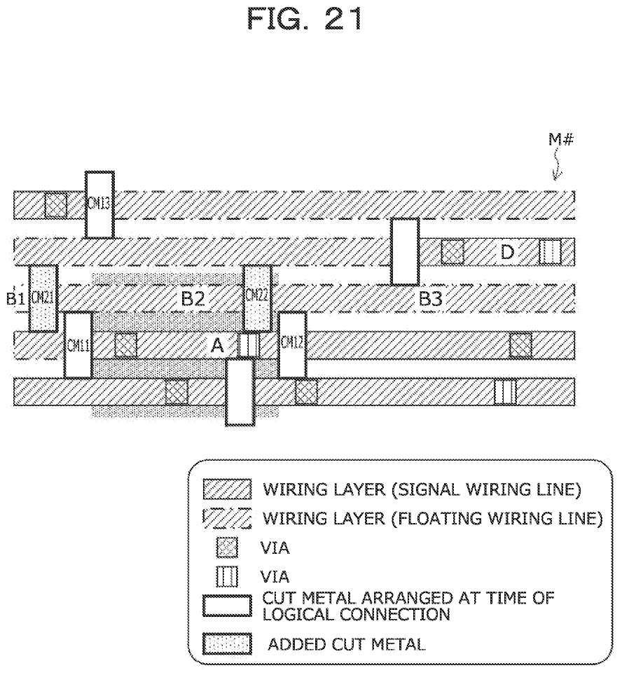

In FIG. 21, an arrangement unit 405 arranges a new cut metal at the determined arrangement position. Here, a cut metal CM21 is arranged at the position 2001 (see FIG. 20) on the floating wiring line B, and a cut metal CM22 is arranged at the position 2002 (see FIG. 20) on the floating wiring line B. As a result, the floating wiring line B is divided into floating wiring lines B1, B2, and B3.

Here, the floating wiring lines B1 and B3 do not have a portion parallel to the wiring line of concern A. Therefore, it becomes possible to decouple the capacitive coupling via the floating wiring line on the left side of the cut metal CM21 and on the right side of the cut metal CM22, and to reduce the crosstalk noise.

(Design Support Processing Procedure of Design Support Device 101)

Next, a design support processing procedure of the design support device 101 according to the fourth embodiment will be described.

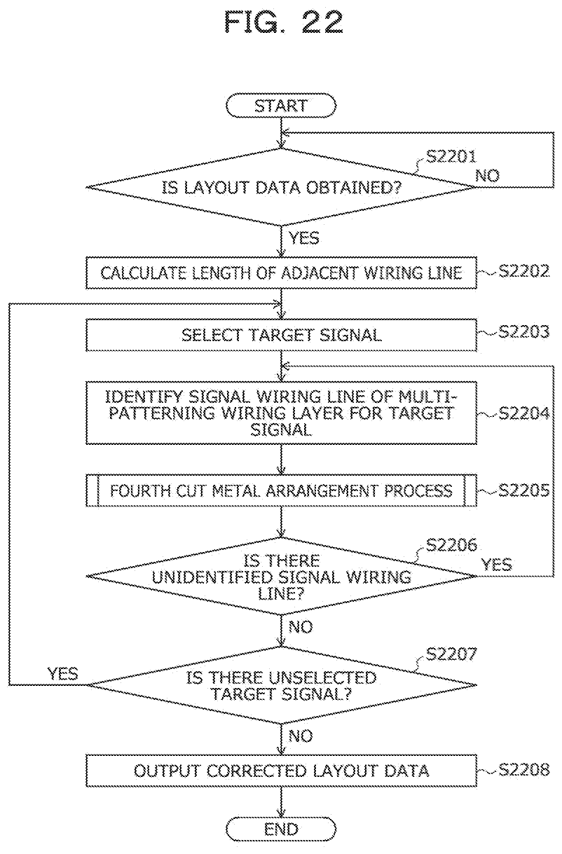

FIG. 22 is a flowchart illustrating an example of the design support processing procedure of the design support device 101 according to the fourth embodiment. In the flowchart of FIG. 22, first, the design support device 101 determines whether or not layout data RD related to the circuit to be designed is obtained (step S2201).

Here, the design support device 101 waits for the layout data RD to be obtained (No in step S2201). Then, if the layout data RD is obtained (Yes in step S2201), the design support device 101 calculates the length L1 of the adjacent wiring line (step S2202).

Then, the design support device 101 refers to a delay evaluation result (STA result) related to the circuit to be designed to select a target signal (step S2203). Next, the design support device 101 identifies a signal wiring line of the multi-patterning wiring layer for the target signal on the basis of the obtained layout data RD (step S2204).

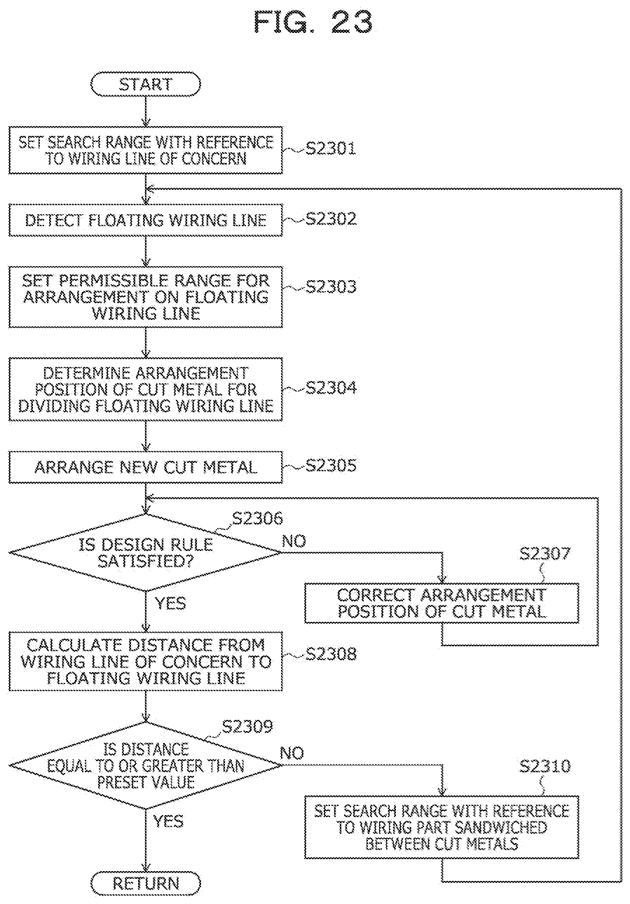

Then, the design support device 101 executes a fourth cut metal arrangement process related to the wiring line of concern, which is the identified signal wiring line (step S2205). A specific processing procedure of the fourth cut metal arrangement process will be described later with reference to FIG. 23.

Next, the design support device 101 determines whether or not there is an unidentified signal wiring line in which the multi-patterning wiring layer is not identified for the target signal on the basis of the obtained layout data RD (step S2206). Here, if there is an unidentified signal wiring line (Yes in step S2206), the design support device 101 returns to step S2204.

On the other hand, if there is no unidentified signal wiring line (No in step S2206), the design support device 101 refers to the delay evaluation result related to the circuit to be designed to determine whether or not there is an unselected target signal that has not been selected (step S2207). Here, if there is an unselected target signal (Yes in step S2207), the design support device 101 returns to step S2203.

On the other hand, if there is no unselected target signal (No in step S2207), the design support device 101 outputs corrected layout data RD′ (step S2208), and terminates the series of processes based on the present flowchart.

As a result, it becomes possible to avoid capacitive coupling via the floating wiring line adjacent to the signal wiring line (wiring line of concern), and to reduce the crosstalk noise.

Next, a specific processing procedure of the fourth cut metal arrangement process in step S2205 will be described with reference to FIG. 23. Here, a case of arranging a new cut metal will be described as an example of the process of arranging the cut metal on the floating wiring line.

FIG. 23 is a flowchart illustrating an example of the specific processing procedure of the fourth cut metal arrangement process. In the flowchart of FIG. 23, first, the design support device 101 sets a search range AR in the wiring direction adjacent to the wiring line of concern in the multi-patterning wiring layer with reference to the wiring line of concern (step S2301).

Next, the design support device 101 detects a floating wiring line that overlaps with the set search range AR (step S2302). Then, the design support device 101 sets a permissible range for cut metal arrangement on the detected floating wiring line with reference to positions on the floating wiring line facing the respective cut metals arranged at both ends of the wiring line of concern (step S2303).

Next, the design support device 101 determines any position within the set permissible range for arrangement as the arrangement position of the cut metal for dividing the floating wiring line (step S2304). Then, the design support device 101 arranges a new cut metal at the determined arrangement position (step S2305).

Next, the design support device 101 determines whether or not the arranged cut metal satisfies the design rule of the circuit to be designed (step S2306). Here, if the design rule is not satisfied (No in step S2306), the design support device 101 corrects the arrangement position of the arranged cut metal (step S2307), and returns to step S2306.

On the other hand, if the design rule is satisfied (Yes in step S2306), the design support device 101 calculates a distance from the wiring line of concern to the detected floating wiring line (step S2308). Then, the design support device 101 determines whether or not the calculated distance is equal to or greater than a preset value (step S2309).

Here, if the distance is less than the preset value (No in step S2309), the design support device 101 refers to the wiring part sandwiched between the arranged cut metals in the detected floating wiring line in the multi-patterning wiring layer to set the search range AR in the wiring direction adjacent to the wiring part (step S2310), and returns to step S2302.

On the other hand, if the distance is equal to or greater than the preset value (Yes in step S2309), the design support device 101 returns to the step in which the first cut metal arrangement process is called.

As a result, it becomes possible to set the permissible range in which the cut metal may be arranged on the floating wiring line adjacent to the wiring line of concern, and to determine the arrangement position of the cut metal for dividing the floating wiring line within the permissible range.

As described above, according to the design support device 101 according to the fourth embodiment, it becomes possible to set a permissible range for cut metal arrangement on the floating wiring line with reference to positions on the floating wiring line facing the respective cut metals arranged at both ends of the wiring line of concern. In addition, according to the design support device 101, it becomes possible to determine any position within the set permissible range for arrangement as the arrangement position of the cut metal for dividing the floating wiring line.

With this arrangement, it becomes possible to flexibly take measures in consideration of arrangement restrictions other than crosstalk noise, such as design rules, even in a case where it is not possible to arrange new cut metals on the extension of the cut metals at both ends of the wiring line of concern in the floating wiring line.

As described above, according to the design support device 101 according to the first to fourth embodiments, an effective position for decoupling the capacitive coupling via the floating wiring line is determined for the circuit to be designed using wiring based on the multi-patterning technology, and a cut metal is inserted into that position, whereby it becomes possible to reduce crosstalk noise efficiently.

Note that each of the first to fourth embodiments may be implemented in combination as long as no contradiction arises. For example, the design support device 101 according to the fourth embodiment may have functions same as those of the design support device 101 according to the third embodiment.

Furthermore, the design support method described in the present embodiments may be implemented by executing a prepared program on a computer such as a personal computer or a workstation. The design support program is recorded on a computer-readable recording medium such as a hard disk, a flexible disk, a CD-ROM, a DVD, or a USB memory, and is read from the recording medium to be executed by the computer. Furthermore, the design support program may be distributed via a network such as the Internet.

Furthermore, the design support device 101 described in the present embodiments may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a design support program for causing a computer to execute a process comprising:
identifying a signal wiring line of a multi-patterning wiring layer on a basis of layout data related to a circuit to be designed, and detecting a floating wiring line that is adjacent to the identified signal wiring line and has a part parallel to the signal wiring line; and
determining an arrangement position of a cut metal that divides the detected floating wiring line on a basis of arrangement positions of cut metals arranged at both ends of the signal wiring line.

2. The non-transitory computer-readable recording medium storing a design support program according to claim 1, wherein
the determining
determines a position on the floating wiring line that faces each of the cut metals arranged at both ends as the arrangement position of the cut metal that divides the floating wiring line.

3. The non-transitory computer-readable recording medium storing a design support program according to claim 1, the process further comprising:
arranging the cut metal at the determined arrangement position.

4. The non-transitory computer-readable recording medium storing a design support program according to claim 3, the program causing the computer to execute the process further comprising:
determining whether or not a design rule of the circuit to be designed is satisfied with respect to the cut metal arranged at the determined arrangement position; and
in a case where the design rule is not satisfied, correcting the arrangement position of the arranged cut metal to any position on the floating wiring line in such a manner that the design rule is satisfied and a distance between positions before and after correction is minimized.

5. The non-transitory computer-readable recording medium storing a design support program according to claim 3, wherein
the detecting
sets a predetermined search range in a wiring direction adjacent to the signal wiring line in the multi-patterning wiring layer with reference to the signal wiring line, and detects a floating wiring line that overlaps with the set search range, and
sets the search range in a wiring direction adjacent to a wiring part with reference to the wiring part sandwiched between the arranged cut metals in the floating wiring line in the multi-patterning wiring layer until a distance from the signal wiring line to the detected floating wiring line becomes equal to or greater than a preset value, and detects a floating wiring line that overlaps with the set search range.

6. The non-transitory computer-readable recording medium storing a design support program according to claim 3, the process further comprising:
arranging one or a plurality of cut metals in a wiring part on the floating wiring line divided by the arranged cut metal in such a manner that the design rule of the circuit to be designed is satisfied.

7. The non-transitory computer-readable recording medium storing a design support program according to claim 3, the process further comprising:
outputting the layout data in which the cut metal is arranged at the determined arrangement position.

8. The non-transitory computer-readable recording medium storing a design support program according to claim 1, the process further comprising:
setting a permissible range for cut metal arrangement on the floating wiring line with reference to a position on the floating wiring line that faces each of the cut metals arranged at both ends, wherein
the determining
determines any position within the set permissible range for arrangement as the arrangement position of the cut metal that divides the floating wiring line.

9. A computer-implemented design support method comprising:
identifying a signal wiring line of a multi-patterning wiring layer on a basis of layout data related to a circuit to be designed, and detecting a floating wiring line that is adjacent to the identified signal wiring line and has a part parallel to the signal wiring line; and
determining an arrangement position of a cut metal that divides the detected floating wiring line on a basis of arrangement positions of cut metals arranged at both ends of the signal wiring line.

10. A design support device comprising:
a memory; and
a processor coupled to the memory, the processor being configured to perform processing, the processing including:
identifying a signal wiring line of a multi-patterning wiring layer on a basis of layout data related to a circuit to be designed, and detect a floating wiring line that is adjacent to the identified signal wiring line and has a part parallel to the signal wiring line; and
determining an arrangement position of a cut metal that divides the detected floating wiring line on a basis of arrangement positions of cut metals arranged at both ends of the signal wiring line.
